(19) United States
(12) Patent Application Publication
(10) Pub. No.: US 2025/0279271 A1
(43) Pub. Date: Sep. 4, 2025

(54) Data Independent Acquisition Mass Spectrometry with Charge State Reduction by Proton Transfer Reactions

(71) Applicant: DH Technologies Development Pte. Ltd., Singapore (SG)

(72) Inventors: Takashi BABA, Richmond Hill (CA); Pavel RYUMIN, Toronto (CA)

(73) Assignee: DH Technologies Development Pte. Ltd., Singapore (SG)

(21) Appl. No.: 18/857,628

(22) PCT Filed: Apr. 25, 2023
(86) PCT No.: PCT/IB2023/054222

§ 371 Date: Oct. 17, 2024

Related U.S. Application Data
(60) Provisional application No. 63/334,378, filed on Apr. 25, 2022.

(51) Int. Cl. H01J 49/00

(52) U.S. Cl. CPC H01J 49/005

(57) ABSTRACT

In one aspect, a method for mass spectrometric analysis of analyte ions is disclosed, which includes filtering a plurality of ions to sequentially transmit a plurality of precursor ion subsets to a charge reduction device (e.g., a proton reaction device). For each precursor ion subset, a charge reduction reaction is performed within the proton reaction device to generate a set of charge-reduced precursor ions associated with one of the precursor ion subsets. One or more portions of the set of charged-reduced product ions associated with each respective precursor ion subset are selectively transmitted to a fragmentation device. The charge-reduced precursor ions are fragmented in the fragmentation device to generate a set of fragment ions associated with each respective precursor ion subset and mass spectra of each set of fragment ions associated with a respective precursor ion subset are generated.

### RELATED APPLICATIONS

This application claims priority to U.S. provisional application No. 63/334,378 filed on Apr. 25, 2022, entitled “DIA PTR” which is incorporated herein by reference in its entirety.

### TECHNICAL FIELD

The present disclosure is generally directed to methods and systems for performing mass spectrometry, and more particularly, to such methods and systems in which analyte ions of interest are subjected to charge reduction, for example, to reduce interference in MS and MS/MS analysis.

### BACKGROUND

Mass spectrometry (MS) is an analytical technique for characterizing molecular structure of test substances with both quantitative and qualitative applications. For example, MS can be used to identify unknown compounds, to determine the isotopic composition of elements in a molecule, and to determine the structure of a particular compound by observing its fragmentation, as well as to quantify the amount of a particular compound in a sample.

DIA/SWATH mass analysis has been established as a go-to strategy for unbiased quantitative omics analysis including proteomics, metabolomics, lipidomics, etc. It has been reported that such mass analysis can benefit from enhanced sensitivity and selectivity. It has also been reported that improved selectivity can be favorably traded for improved sensitivity by providing larger isolation windows while maintaining the same separation power.

### SUMMARY

In one aspect, a method for mass spectrometric analysis of analyte ions is disclosed, which includes filtering a plurality of ions to sequentially transmit a plurality of precursor ion subsets (multiply-charged precursor ion subsets, which can be typically peptides) to a charge reduction device (e.g., a proton transfer reaction (PTR) device). For each precursor ion subset, a charge reduction reaction is performed within the proton transfer reaction device to generate a set of charge-reduced precursor ions associated with one of the precursor ion subsets. One or more portions of the set of charged-reduced precursor ions associated with each respective precursor ion subset are selectively transmitted to a fragmentation device. The charge-reduced precursor ions are fragmented in the fragmentation device to generate a set of fragment ions. Mass spectra associated with each respective precursor ion subset and mass spectra of each set of fragment ions associated with a respective precursor ion subset are generated and the mass spectra are analyzed to correlate fragment ions to a respective precursor ion from which the fragment ions were generated.

In some embodiments, a mass filter is configured to transmit the plurality of precursor ion subsets to the charge reduction device, where ions within each precursor ion subset are within a different m/z window established by the mass filter.

In some embodiments, an ion mobility device can be configured to transmit the plurality of precursor ion subsets to the charge reduction device, where ions within each precursor ion subset are within a different ion mobility window established by the mobility device.

In some embodiments, one or more portions of the set of charge-reduced precursor ions associated with each respective precursor ion subset can be selectively transmitted to the fragmentation device based on their m/z ratios. For example, the charge-reduced precursor ions can be mass selectively extracted from the charge reduction device for introduction into the fragmentation device.

In some embodiments, the charge-reduced precursor ions can be trapped in an ion trap disposed between the charge reduction device and the fragmentation device prior to being selectively transmitted to the fragmentation device. In some such embodiments, the charge-reduced precursor ions can be ejected from the charge reduction device into the ion trap upon being charge-reduced.

In some embodiments, mass spectra of each set of charge-reduced precursor ions are obtained prior to one or more portions of the respective set of charge-reduced precursor ions being selectively transmitted to the fragmentation device and area of the mass spectra in which the charge-reduced precursor ions are not present are identified and parameters for selectively transmitting the one or more portions of the set of charge-reduced ions are adjusted based on the identified areas.

In some embodiments, one or more portions of the set of charge-reduced precursor ions associated with each precursor ion subset are selectively transmitted to the fragmentation device based on their ion mobility.

In some embodiments, the charge-reduced precursor ions are trapped in an ion trap disposed between the charge reduction device and the fragmentation device prior to being selectively transmitted to the fragmentation device.

By way of example, the fragmentation device can be a collision cell in which the charge-reduced ions can undergo collisional fragmentation.

In some embodiments, the mass spectra of the fragments of the charge-reduced ions are acquired using, for example, a time-of-flight (ToF) mass analyzer.

In a related aspect, a system for mass spectrometric analysis of ions is disclosed, which includes an ion filtering device, a proton transfer reaction device, a fragmentation device, a mass analyzer, and a controller comprising a processor and configured to: cause the ion filtering device to sequentially transmit a plurality of precursor ion subsets to a proton transfer reaction device; cause the proton transfer reaction device to perform a charge reduction reaction so as to generate a set of charge-reduced precursor ions associated with each precursor ion subset; cause one or more portions of the set of charge-reduced precursor ions associated with each respective precursor ion subset to be selectively transmitted to the fragmentation device; cause the fragmentation device to fragment the charge-reduced precursor ions as each of the one or more portions are received by the fragmentation device to generate a set of fragment ions associated with each respective precursor ion subset; and cause the mass analyzer to obtain mass spectra of the set of fragment ions associated with each respective precursor ion subset.

Further understanding of various aspects of the present teachings can be obtained by reference to the following detailed description in conjunction with the associated drawings, which are described briefly below.

### BRIEF DESCRIPTION OF THE DRAWINGS

FIG. 1A is a flow chart depicting various steps in an embodiment of a method according to the present teachings for performing mass spectrometry,

FIG. 1B is a flow chart depicting various steps in an example of implementation of a method according to the present teachings for performing mass spectrometry,

FIG. 2A is a schematic view of a mass spectrometer according to an embodiment of the present teachings,

FIG. 2B schematically depicts an example of application of DC and AC voltages to the rods and the gate electrodes of a PTR device for providing mutual entrapment of analyte ions and reagent ions in the PTR device (the same voltages can be used to achieve mass selective ion extraction),

FIG. 2C schematically depicts the principle of charge reduction by which the charge state of analyte ions is reduced via reaction with a charge-reducing reagent,

FIG. 3 is a schematic view of a mass spectrometer according to an embodiment in which an ion trap is positioned downstream of a PTR cell for receiving charge-reduced precursor ions generated in the PTR cell, where the ions are released in a mass dependent manner from the ion trap to be introduced into a downstream collision cell,

FIG. 4 is a schematic view of a mass spectrometer according to another embodiment in which the charge reduced ions generated via charge reduction of analyte ions are released to a downstream ion storage device so as to inhibit the analyte ion from undergoing multiple charge reduction reactions,

FIG. 5 is a schematic view of a mass spectrometer according to another embodiment in which a differential mobility mass spectrometer is used upstream of a PTR device for use as an ion separation device,

FIG. 6 is a schematic view of a mass spectrometer according to another embodiment in which a low-field ion mobility device is positioned downstream of a PTR device to provide further separation of the ions in the m/z space, and

FIG. 7 schematically depicts an example of an implementation of a controller/analysis module suitable for use in the practice of the present teachings.

### DETAILED DESCRIPTION

It will be appreciated that for clarity, the following discussion will explicate various aspects of embodiments of the present disclosure, while omitting certain specific details wherever convenient or appropriate to do so. For example, discussion of like or analogous features in alternative embodiments may be somewhat abbreviated. Well-known ideas or concepts may also for brevity not be discussed at any great detail. One of ordinary skill will recognize that some embodiments of the present disclosure may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and, “substantially, and “substantially equal” refer to variations in a numerical quantity and/or a complete state or condition that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

As used herein, two components are in “communication” with one another or are “coupled” or “operably coupled” to one another when ions, e.g., entrained in a gas flow, can be exchanged between them.

Reducing the charge state of analyte ions is a practical way of eliminating interference in MS and MS/MS analysis. For example, the use of a PTR device allows increasing the separation of charged species in the m/z space. In order to utilize this enhancement in m/z separation in a DIA workflow, the extra separation in the m/z space needs to be converted to enhanced temporal separation of ions with different m/z ratios. Further, as discussed in more detail below, in some embodiments, separation devices such as ion mobility devices can be used together with a charge reduction device to provide, e.g., additional selectivity post charge reduction. For example, mass selective ion release or ion mobility selective ion release of the charge-reduced species can be employed as a way of providing temporal separation of the ions. As discussed in more detail below, in some embodiments, it is advantageous to perform PTR and mass selective or ion mobility selective ion release in parallel. As such, in some embodiments, PTR and mass selective or ion mobility selective ion release are implemented in independent devices. For example, as discussed in more detail below, charge reduced ions generated in a PTR device can be transferred to a downstream ion trap and then released from the ion trap in a mass selective manner.

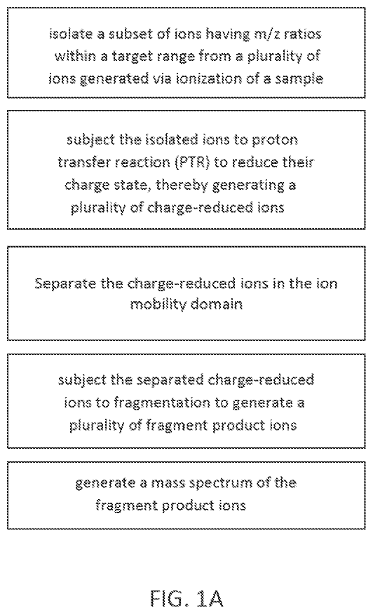

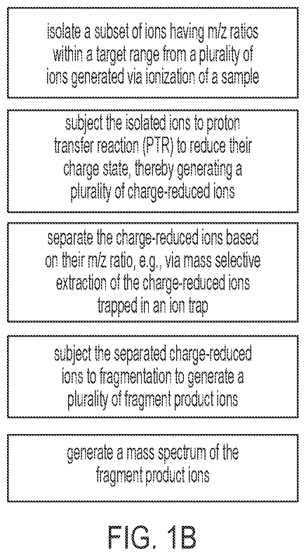

FIG. 1A is a flow chart depicting various steps of a method according to an embodiment for performing DIA (data independent analysis) mass spectrometry in which a plurality of precursor ions having an m/z ratio in a target range is isolated from a collection of analyte ions generated via ionization of a sample and the isolated precursor ions are subjected to a charge reduction reaction to reduce their charge state and hence generate a plurality of charge-reduced ions (e.g., via introduction of the precursor ions into a proton transfer reaction (PTR) device in which they are mutually trapped with an oppositely charged reagent ion and undergo a charge reduction reaction). The charge-reduced ions are then separated in the ion mobility domain, e.g., via passage through an ion mobility mass spectrometer. The charge-reduced ions can then be fragmented (e.g., via collisional fragmentation) to generate a plurality of fragment ions, which can then be mass analyzed to generate a mass spectrum thereof.

In some embodiments, the charge-reduced ions are subjected to ion separation via mass selective separation, i.e., based on their m/z ratios, and the separated charge-reduced ions are subsequently fragmented, e.g., via collisional fragmentation, to generate a plurality of fragment ions. By way of illustration, FIG. 1B is a flow chart depicting various steps of a method according to such an embodiment for performing DIA (data independent analysis) mass spectrometry in which a plurality of precursor ions having an m/z ratio in a target range is isolated from a collection of analyte ions generated via ionization of a sample and the isolated precursor ions are subjected to a charge reduction reaction to reduce their charge state and hence generate a plurality of charge-reduced ions (e.g., via introduction and mutual trapping of the precursor ions and the reagent ions in a proton transfer reaction (PTR) device in which the precursor ions can undergo a charge reduction reaction with the reagent ions).

The charge-reduced ions are separated based on their m/z ratios and subsequently are fragmented (e.g., via collisional fragmentation) to produce a plurality of fragment ions. The fragment ions can then be mass analyzed to generate a mass spectrum thereof. As the fragment ions are separated in time for analysis, it is possible to associate fragment ion mass spectra with precursor ion mass spectra and hence identify a precursor ion that resulted in generation of a respective set of the fragment ions.

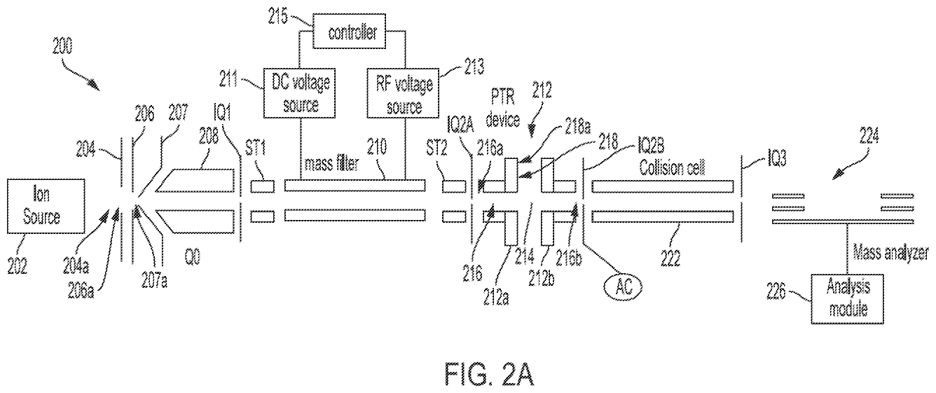

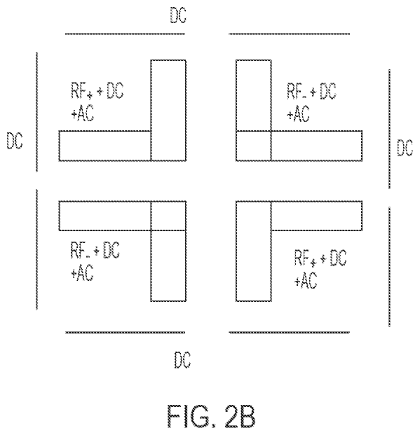

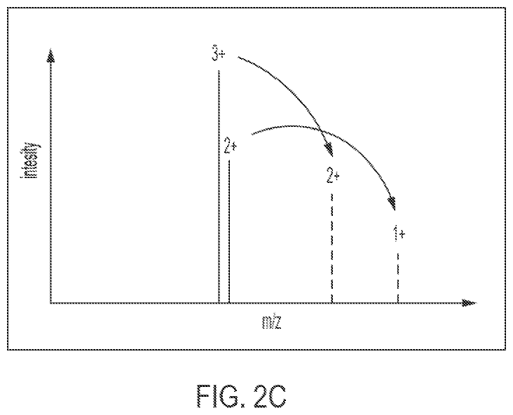

FIG. 2A schematically depicts a mass spectrometer 200 according to an embodiment of the present teachings that is configured for performing DIA/SWATH analysis of a sample. The mass spectrometer 200 includes an ion source 202 that can receive a sample and ionize at least one or more analytes of interest in the sample to generate a plurality of analyte ions. The ions can pass through an orifice 204a of a curtain plate 204 and an orifice 206a of an orifice plate 206, which is positioned downstream of the curtain plate and is separated from the curtain plate such that a gas curtain chamber is formed between the orifice and the curtain plate. A curtain gas supply (not shown) can provide a curtain gas flow (e.g., of N₂) between the curtain plate 204 and the orifice plate 206 to help keep the downstream sections of the mass spectrometer clean by declustering and evacuating large neutral particles. The curtain chamber can be maintained at an elevated pressure (e.g., a pressure greater than the atmospheric pressure) while the downstream sections of the mass spectrometer can be maintained at one or more selected pressures via evacuation through one or more vacuum pumps (not shown).

In this embodiment, the ions then pass through an orifice 207a of a skimmer 207 to be received by an ion guide Q0, which comprises four rods 208 (two of which are visible in this figure) that are arranged in a quadrupole configuration to form an ion beam for transmission to downstream components of the mass spectrometer.

The ion beam exits the Q0 ion guide and is focused via an ion lens IQ1 and a stubby lens ST1 into a subsequent ion mass filter Q1, which includes four rods 210 (two of which are visible in this figure) that are arranged in a quadrupole configuration and to which RF voltages as well as a DC resolving voltage can be applied for radially focusing the ions and selecting ions having m/z ratios within a target range (herein referred to as precursor ions) as they pass through the Q1 mass filter. By way of example, in this embodiment, a DC voltage source 211 and an RF voltage source 213 operating under control of a controller 215 can apply the requisite RF and DC voltages to the rods of the mass filter Q1.

More specifically, in this embodiment, the quadrupole rod set Q1 can be operated as a conventional transmission RF/DC quadrupole mass filter for selecting ions having m/z ratios within a target range suitable for DIA mass analysis of a sample of interest. For example, parameters of the applied RF and DC voltages can be selected so that Q1 establishes a transmission window of chosen m/z ratios, such that these ions can traverse Q1 largely unperturbed. Ions having m/z ratios falling outside the window, however, do not attain stable ion trajectories within the quadrupole and can be prevented from traversing the quadrupole rod set Q1. It should be appreciated that this mode of operation is but one possible mode of operation for Q1.

The ions passing through the Q1 mass filter are focused via a stubby lens ST2 and an ion lens IQ2A into a PTR (proton transfer reaction) device 212. In this embodiment, the PTR device (herein also referred to as PTR cell) 212 is in the form of a branched RF ion trap, which can receive the precursor ions passing through the upstream mass filter Q1 and trap the received ions so that they can interact with a plurality of reagents ions for reducing the charge state of the trapped analyte ions.

More specifically, the PTR device 212 includes two sets of L-shaped quadrupole rods 212a/212b (only two rods of each set are visible in the figure) that are axially separated from one another to provide an ion trapping region 214 therebetween. Further, the two sets of the quadrupole rods are arranged relative to one another so as to provide a longitudinal passageway (herein also referred to as a longitudinal channel or a longitudinal branch) 216 and a transverse passageway (herein also referred to as a transverse channel or a transverse branch) 218. The longitudinal channel includes an inlet 216a through which the ions exiting the mass filter Q1 can enter the PTR cell and an outlet 216b through which the charge reduced ions can exit the PTR cell. Two ion lenses IQ2a and IQ2b, which can function as gate electrodes, are positioned in proximity of the inlet 216a and the outlet 216b of the PTR device.

A plurality of reagent ions can be introduced into the PTR cell via an inlet 218a of the transverse channel and can be trapped together with the precursor ions to react with the precursor ions and cause a charge reduction thereof.

The mutual trapping of the analyte ions and the reagent ions within the ion trap 212 can be achieved via application of RF, DC and AC voltages to the rods and the gate electrodes of the ion trap. By way of illustration, FIG. 2B shows an example of application of RF, DC and AC voltages to the rods and the gate electrodes of the ion trap 212 for achieving mutual trapping of positively-charged analyte ions and negatively-charged reagent ions in the PTR device such that the negatively-charged reagent ions can interact with the positively-charged analyte ions to cause a reduction in the charge state of the positively-charged analyte ions. Alternatively, positively-charged reagent ions (e.g., positively-charged xenon ions) can be used to reduce the charge state of negatively-charged analyte ions.

By way of further illustration, FIG. 2C schematically depicts the principle of PTR separation. In this example, a doubly and a triply charged precursor ion having close m/z ratios react with a negatively charged reagent ion in a PTR device to lose a single charge. Subsequent to such a charge reduction reaction, the separation of the ions in the m/z space increases and hence they become more amenable to further m/z separation, e.g., in mass selection and/or ion mobility domain. This can in turn advantageously enhance the selectivity of the DIA mass analysis.

The charge-reduced ions are then extracted from the PTR device 212 using mass selective extraction. For example, with reference to FIG. 2A, the AC voltage applied to the gate electrode IQ2B provides a pseudopotential barrier that depends on the m/z ratio of the trapped ions. Accordingly, this AC voltage can be adjusted to achieve mass selective extraction of the charge-reduced ions from the PTR device 212. For example, by ramping down the barrier AC voltage, the charge-reduced ions can be released in a high to low m/z ratio release profile.

The ions released from the PTR device 212 are introduced into a collision cell 222 in which the released charge-reduced ions undergo collisional fragmentation to generate a plurality of fragment ions (herein also referred to as “fragment product ions” or simply as “product ions”). The fragment ions are received by a downstream mass analyzer 224 that can provide mass spectral data associated with the fragment ions. An analysis module 226 in communication with the mass analyzer can receive the mass spectral data and generate a mass spectrum of the fragment ions. The mass spectral data can be utilized to associate the precursor ion from which the fragment product ions were produced with the fragment ions in a manner known in the art.

In one embodiment of a mass spectrometer according to the present teachings, an ion trap can be positioned downstream from the PTR device 212 to receive the charge reduced ions. The charge-reduced ions can then be released from the ion trap, e.g., via mass selective extraction, to be introduced into a downstream collision cell. Such an embodiment can advantageously allow reloading of the PTR device with a new batch of analyte ions after the release of a previous batch into the ion trap. In other words, in such a mass spectrometer, the steps of PTR and a second ion separation can be performed in parallel. In other words, in contrast to the previous embodiment in which during the processing of a batch of ions, the ions received from the ion source need to be discarded, in this embodiment, the charge-reduced ions can be transferred to a downstream trap while a new batch of ions is received from the ion source. Typically, the PTR and the second separation (e.g., via mass selective extraction from a downstream ion trap) are performed over a time scale of 10 s of milliseconds.

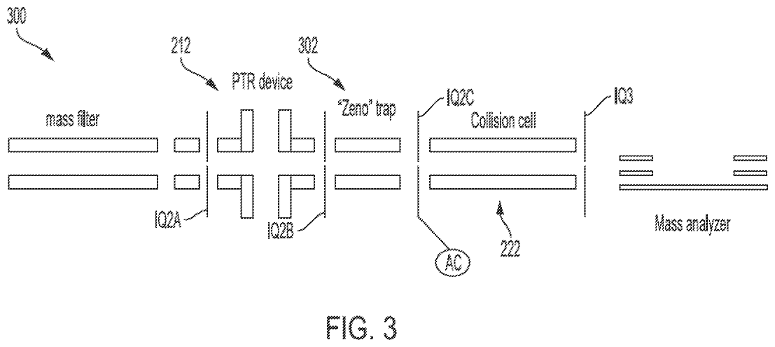

By way of example, FIG. 3 schematically depicts an example of such a mass spectrometer 300 according to an embodiment of the present teachings that is configured for DIA/SWATH analysis of a sample and in which a second separation device in the form of an ion trap, which uses an auxiliary ramped AC field to separate ions, is employed downstream of a PTR device, allowing both the PTR and the second m/z separation to occur concurrently. After one batch of ions has undergone PTR, the generated charge-reduced ions are transferred to the ion trap and while further m/z separation is performed via the ion trap, another batch of ions is introduced into the PTR device.

More specifically, the mass spectrometer 300 is similar to the above mass spectrometer 200 except for the incorporation of an ion trap 302 between the PTR device 212 and the collision cell 222. In this embodiment, an inlet gate electrode IQ2A and an outlet gate electrode IQ2B, to which DC and AC voltages can be applied, are employed to facilitate the mutual entrapment of the analyte ions and the charge-reducing reagent ions within the ion trap. Subsequent to the introduction of the analyte ions into the PTR device and passage of sufficient time to allow the reaction of the analyte ions with the charge-reducing reagent ions to proceed, the gate voltage applied to the outlet gate electrode IQ2B can be adjusted to allow the release of the charge-reduced ions from the PTR device and their introduction into the ion trap 302. Typically, the applied AC voltage is dropped and unreacted reagent ions are removed from the PTR device followed by adjusting the DC voltage to allow the charge-reduced ions to exit the PTR device and be received by the ion trap 302. After the release of the charge-reduced ions into the ion trap 302, the voltage applied to the gate electrode IQ2B can be adjusted to allow trapping of a new batch of precursor ions in the PTR device 212.

A combination of DC and AC voltages applied to the gate electrode IQ2B and a gate electrode IQ2C positioned between the ion trap 302 and the downstream collision cell 222 can trap the charge-reduced ions within the ion trap 302, e.g., in a manner discussed above. Further, an AC voltage applied to the gate electrode IQ2C can generate an m/z-dependent pseudopotential barrier that can be ramped to allow mass dependent release of the trapped charge-reduced ions from the ion trap into the collision cell 222.

The charge-reduced ions can undergo collisional fragmentation in the collision cell via collision with molecules of a buffer gas to generate a plurality of fragment ions, which can be received by a downstream mass analyzer. Fragment ions pass through the collision cell and are received by the mass analyzer. By way of example, the mass analyzer can be a time-of-flight mass analyzer in which an accelerating voltage applied to a push electrode is pulsed at a high frequency to sample the received ions. Such an operation of the ToF mass analyzer can allow the conversion of m/z separated ions to time separated ions with the high sampling frequency effectively creating an independent fragment mass spectra data record for each respective precursor ion.

The mass analyzer can generate mass spectral data that can be analyzed in a manner known in the art to generate a mass spectrum of the fragment ions. The fragment ions can then be associated with their respective precursor ions, e.g., in a manner used in the art in DIA workflows.

In some embodiments, an AC pseudo potential barrier generated via application of an AC voltage to a gate electrode positioned in proximity of an outlet of the PTR device can be configured such that charge reduced ions, following their formation, can overcome the AC pseudopotential barrier to exit the PTR device to be introduced into an ion storage device. In this manner, the charge reduction reaction can be quenched and hence inhibit multiple reductions in the charge state of the analyte ions. For example, the AC pseudopotential barrier can be configured to exhibit a mass cutoff that would inhibit the leakage of the analyte ions from the PTR device while allowing the charge-reduced ions to exit the PTR device. In this manner, the charge-reduced ions exit the PTR device following their formation, thus quenching the charge reduction reaction. The charge-reduced ions can then be released from the ion storage device to a downstream ion separation device, such as those described herein.

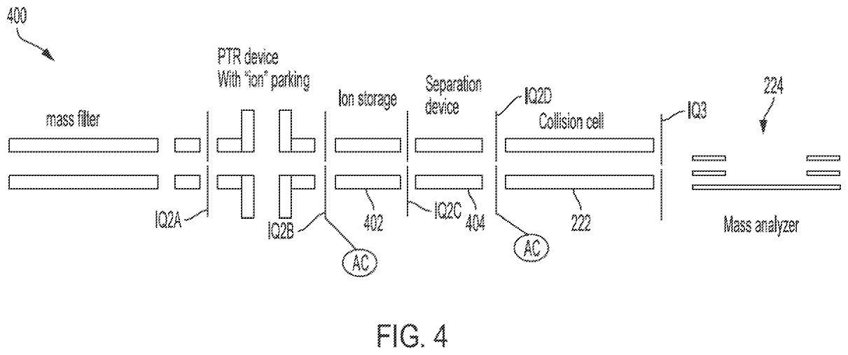

By way of example, FIG. 4 schematically depicts an example of a mass spectrometer 400 according to such an embodiment in which an AC voltage applied to the outlet gate electrode IQ2B provides a pseudopotential AC barrier, which can help trap the analyte ions, but allow the exit of the charge-reduced ions from the PTR device. In other words, the charge-reduced ions can overcome the AC pseudopotential barrier to exit the PTR device and be received by a downstream ion storage device 402. This allows quenching of the charge-reduction reaction and hence prevent the analyte ions from undergoing multiple charge-reduction reactions.

The charge-reduced ions stored in the ion storage device 402 can then be released from the ion storage device into an ion separation device 404 via adjusting a voltage applied to a gate electrode IQ2C positioned between the ion storage device 402 and the ion separation device 404. For example, a DC barrier voltage applied to the gate electrode IQ2C can be lowered in order to release the charge-reduced ions stored in the ion storage device 402 into the downstream separation device 404.

In this embodiment, the ion separation device 404 can be an ion trap that can receive and trap the ions and allow mass selective release of the trapped ions.

A gate electrode IQ2D is positioned between the outlet of the ion trap and the inlet of the downstream collision cell 222. The application of a combination of DC and AC voltages to the gate electrode IQ2D can allow trapping the charge-reduced ions in the ion trap. Further, the AC voltage can be adjusted, e.g., ramped down, to allow mass selective extraction of the charge-reduced ions from the ion trap for their introduction into the downstream collision cell 222 in which the released charge-reduced ions can undergo collisional fragmentation to generate a plurality of fragment ions. The ions passing through the collision cell are received by the downstream mass analyzer 224, which can generate mass spectral data associated with the fragment ions. Similar to the previous embodiments, the mass spectral data can be used to associate the fragment ions with respective precursor ions.

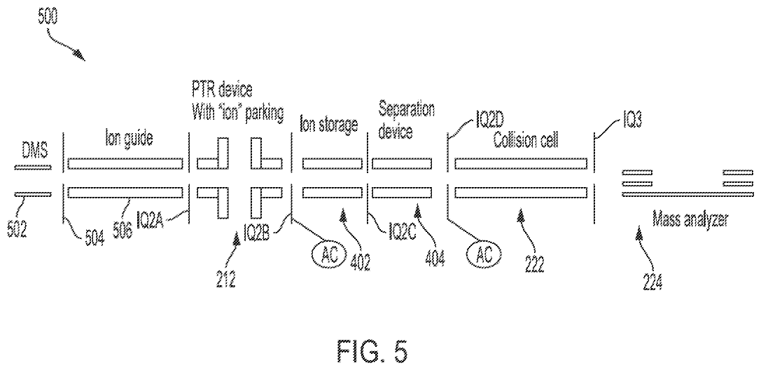

FIG. 5 is a partial schematic view of a mass spectrometer 500 according to an embodiment, which includes an upstream ion mobility separation device, which in this embodiment is a differential mobility mass spectrometer (DMS) that can receive a plurality of analyte ions and cause their separation based on their mobility. The range of m/z ratios that can pass through the DMS for a given compensation voltage depends on the resolving power of the DMS. As the compensation voltage is ramped (or stepped through a series of discrete values), ions in different m/z ranges pass through the DMS. The ions exiting the DMS are directed via an ion lens 504 into an ion guide 506, which in turn guides the ions to the downstream PTR device 212.

In this embodiment, the ion guide 506 can be implemented as a quadrupole ion guide using four rods that are arranged in a quadrupole configuration and to which RF voltages can be applied for providing radial confinement of the ions. In other embodiments, other multipole configurations, such as hexapole, octupole, etc. can be employed or alternatively stack ring ion guides known in the art can be also used.

The ions exiting the ion guide 506 are received by the PTR device 212 in which they undergo a charge-reduction reaction via interaction with a plurality of charge-reducing reagent ions that are introduced into the PTR device 212 via a transverse inlet thereof. The analyte ions and the charge-reducing reagents ions can be mutually trapped within the PTR device 212, for example, in a manner discussed above. Similar to the previous embodiments, an AC voltage applied to an exit gate electrode IQ2B of the PTR device 212 can be ramped to allow mass dependent extraction of the charge-reduced ions from the PTR device.

Similar to the mass spectrometer described above in connection with FIG. 4, the released charge-reduced ions are introduced into an ion storage device 402 and are subsequently introduced into an ion separation device 404, in a manner discussed above. The ions extracted, e.g., via mass selective extraction in this embodiment, from the ion separation device are introduced into the collision cell 222 in which the charge-reduced ions can undergo collisional fragmentation to generate a plurality of fragment ions, which are in turn mass analyzed via the downstream mass analyzer 224.

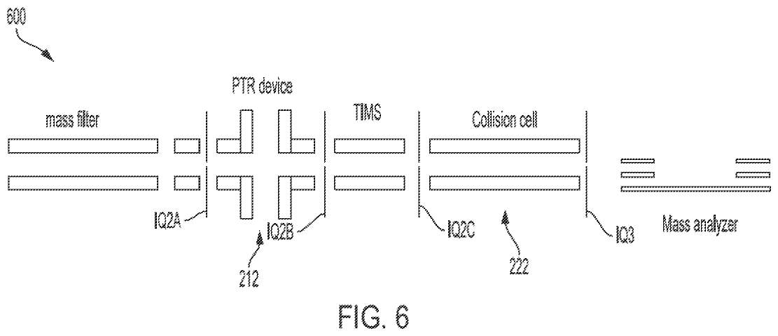

FIG. 6 is a partial schematic view of a mass spectrometer 600 according to an embodiment in which a trapped ion mobility mass spectrometer (TIMS) 602 is positioned downstream of the PTR device 212 to provide further separation of the charge-reduced ions released from the PTR device.

As is known to those having ordinary skill in the art, a TIMS device can be used to separate ionized molecules in the gas phase based on their mobility in a flowing carrier gas. In TIMS, a radio frequency (RF) electromagnetic field radially confines the ions in an ion channel while a flowing carrier gas drags ions along the ion channel. An electric field exerts an electric force on the ions in a direction opposite to the direction of the flowing carrier gas. The competing drag and electric forces act to separate the ions as a function of their mass-to-charge ratio and as a function of their collisional cross-section. By way of example, and without limitation, an example of an TIMS suitable for use in the practice of the present teachings is described in U.S. Pat. No. 6,630,662 titled “Setup for mobility separation of ions implementing an ion guide with an axial field and counterflow of gas,” which is herein incorporated by reference in its entirety.

The TIMS provides a continuous stream of ions, separated based on their m/z ratios, that are received by the downstream collision cell 222 in which the charge-reduced ions undergo collisional fragmentation due to collisions with molecules of a buffered gas present in the collision cell to generate a plurality of fragment ions. The fragment ions are received by the mass analyzer 224, which generates mass spectral data that can be analyzed to arrive at a mass spectrum of the fragment ions.

In some embodiments, the operation of the mass spectrometer, including the application of DC and/or AC voltages to various gate electrodes as discussed herein, can be controlled by one or more controllers (such as the above controller 215).

A controller and/or an analysis module suitable for use in the practice of the present teachings, such as the above controller 215 and/or the analysis module 226 can be implemented in hardware, firmware and/or software in a manner known in the art as informed by the present teachings.

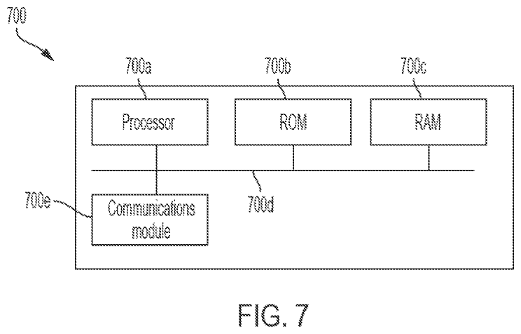

FIG. 7 schematically depicts an example of an implementation of such a controller/analysis module 700, which includes a processor 700a (e.g., a microprocessor), at least one permanent memory module 700b (e.g., ROM), at least one transient memory module (e.g., RAM) 700c, and a communication bus 700d, among other elements generally known in the art.

The communication bus 700d allows communication between the processor and various other components of the controller. In this example, the controller 700 can further include a communications module 700e that is configured to allow sending and receiving signals.

Instructions for use by the controller/analysis module 700 for controlling the operation of the mass spectrometer, e.g., application of DC and AC voltages to various gate electrodes, and/or analyzing the mass spectral data generated by the mass analyzer and processing the mass spectral data to generate a mass spectrum of the fragment product ions can be stored in the permanent memory 700b and can be transferred during runtime into the transient memory module 700c for execution.

Those having ordinary skill will appreciate that various changes may be made to the above embodiments without departing from the scope of the invention.

The above detailed description refers to the accompanying drawings. The same or similar reference numbers may have been used in the drawings or in the description to refer to the same or similar parts. Also, similarly named elements may perform similar functions and may be similarly designed, unless specified otherwise. Details are set forth to provide an understanding of the exemplary embodiments. Embodiments, e.g., alternative embodiments, may be practiced without some of these details. In other instances, well known techniques, procedures, and components have not been described in detail to avoid obscuring the described embodiments.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature may exist in one or more embodiments

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or. Moreover, if these terms are used, a subset of a set may include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some embodiment, a first variable may be an increasing or a decreasing function of a second variable if, respectively, the first variable is directly or inversely proportional to the second variable.

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments, and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

What is claimed is:

1. A method for analyzing ions, comprising:
filtering a plurality of ions to sequentially transmit a plurality of precursor ion subsets to a proton transfer reaction device;
for each precursor ion subset, performing a charge reduction reaction within the proton transfer reaction device to generate a set of charge-reduced precursor ions associated with one of the precursor ion subsets;
selectively transmitting one or more portions of the set of charge-reduced precursor ions associated with each respective precursor ion subset to a fragmentation device;
fragmenting the charge-reduced precursor ions as each of the one or more portions are received by the fragmentation device to generate a set of fragment ions associated with each respective precursor ion subset; and
obtaining one or more mass spectra of the set of fragment ions, and
associating the one or more mass spectra of the set of fragment ions with each respective precursor ion subset.

2. The method of claim 1, wherein a mass filter is configured to transmit the plurality of precursor ion subsets to the proton transfer reaction device, wherein ions within each precursor ion subset are within a different m/z window established by the mass filter.

3. The method of claim 1, wherein a mobility device is configured to transmit the plurality of precursor ion subsets to the proton transfer reaction device, wherein ions within each precursor ion subset are within a different ion mobility window established by the mobility device.

4. The method of claim 1, wherein the one or more portions of the set of charge-reduced precursor ions associated with each respective precursor ion subset are selectively transmitted to the fragmentation device based on their m/z.

5. The method of claim 4, wherein the charge-reduced precursor ions are mass selectively scanned from the proton transfer reaction device to the fragmentation device.

6. The method of claim 4, wherein the charge-reduced precursor ions are trapped in an ion trap disposed between the proton transfer reaction device and the fragmentation device prior to being selectively transmitted to the fragmentation device.

7. The method of claim 6, wherein the charge-reduced precursor ions are ejected from the proton transfer reaction device into the ion trap upon being charge-reduced.

8. The method of claim 6, further comprising:
obtaining a charge-reduced product ion mass spectra of each set of charge-reduced precursor ions prior to one or more portions of the respective set of charge-reduced precursor ions being selectively transmitted to the fragmentation device;
identifying areas of the charge-reduced product ion mass spectra in which charge-reduced precursor ions are not present; and
adjusting parameters for selectively transmitting the one or more portions of the set of charge-reduced precursor ions based on the identified areas.

9. The method of claim 1, wherein the one or more portions of the set of charge-reduced precursor ions associated with each respective precursor ion subset are selectively transmitted to the fragmentation device based on their ion mobility.

10. The method of claim 9, wherein the charge-reduced precursor ions are trapped in an ion trap disposed between the proton transfer reaction device and the fragmentation device prior to being selectively transmitted to the fragmentation device.

11. The method of claim 1, wherein the fragmentation device comprises a collision cell.

12. The method of claim 11, wherein fragmenting the charge-reduced precursor ions comprises performing collision induced dissociation in the collision cell.

13. The method of claim 1, wherein obtaining one or more mass spectra comprises using a time-of-flight mass analyzer.

14. The method of claim 1, wherein obtaining one or more mass spectra comprises using a time-of-flight mass analyzer.

15. A system for analyzing ions, comprising:
an ion filtering device;
a proton reaction device;
a fragmentation device;
a mass analyzer; and
a controller comprising a processor and configured to:
cause the ion filtering device to sequentially transmit a plurality of precursor ion subsets to a proton reaction device;
cause the proton reaction device to perform a charge reduction reaction so as to generate a set of charge-reduced precursor ions associated with each precursor ion subset;
cause one or more portions of the set of charge-reduced precursor ions associated with each respective precursor ion subset to be selectively transmitted to the fragmentation device;
cause the fragmentation device to fragment the charge-reduced precursor ions as each of the one or more portions are received by the fragmentation device to generate a set of fragment ions associated with each respective precursor ion subset; and
cause the mass analyzer to obtain a mass spectra of the set of fragment ions associated with each respective precursor ion subset.
